(19) United States
(12) Patent Application Publication
(10) Pub. No.: US 2004/0148301 A1
(43) Pub. Date: Jul. 29, 2004

(54) Compressed data structure for a database

(76) Inventors: Christopher W.T. McKay, Auckland (NZ); Steven Skillcorn, Queenstown (NZ); James G. Douvikas, Danville, CA (US)

Correspondence Address: HEWLETT-PACKARD COMPANY, Intellectual Property Administration, P.O. Box 272400, Fort Collins, CO, 80527-2400, US

(21) Appl. No.: 10/350,326

(22) Filed: Jan. 24, 2003

(51) Int. Cl. G06F 7/00

(52) U.S. Cl. 707/101

(57) ABSTRACT

A method of and computer-readable medium containing instructions for storing data in a compressed data structure. The data is stored in compressed form in one or more uniquely identified data pages along with configuration information stored in at least one configuration file. Index information is stored in one or more uniquely identified index pages. The index information includes pointers to data in the uniquely identified data pages and data from one or more fields of data from the uniquely identified data pages. The index information in the index pages is ordered based on the stored index information data from one or more fields of data from the data pages and the ordering basis is stored in configuration information in the one or more configuration files.

### RELATED APPLICATIONS

This application is related to co-pending applications entitled, “Single System for Managing Multi-platform Data Retrieval” (HP Reference 100204177-1); “Compressed Data Structure for Extracted Changes to a Database and Method of Generating the Data Structure” (HP Reference 100204180-1); “Portable Executable Software Architecture” (HP Reference 200207706-1); and “Method of Updating Data in a Compressed Data Structure” (HP Reference 200207707-1), all assigned to the present assignee, all of which are hereby incorporated by reference in their entirety, and all of which are being filed concurrently herewith. This application is also related to co-pending applications entitled, “E-service to Manage and Export Contact Information” (HP Reference 10992821-1), Ser. No. 09/507,043 filed Feb. 18, 2000; “E-Service to Manage Contact Information and Signature Ecards”(HP Reference 10992671-1), Ser. No. 09/507,631 filed Feb. 18, 2000; “E-service to Manage Contact Information and Track Contact Location” (HP Reference 10992821-1), Ser. No. 09/507,043 filed Feb. 18, 2000; and “E-service to Manage Contact Information with Privacy Levels” (HP Reference 10992822-1), Ser. No. 09/507,215 filed Feb. 18, 2000, all assigned to the present assignee, and all of which are hereby incorporated by reference in their entirety.

### FIELD OF THE INVENTION

The present invention relates to a method and apparatus for a data structure for a database, and more particularly, to such a method and apparatus wherein the data structure is compressed.

### BACKGROUND

It is known in the art to compress a database containing data to minimize storage requirements for storing the data and reduce transmission times for transmitting the data. In prior approaches, the entire database is compressed and decompressed or extracted for manipulation/query of the data in the database. For example, prior approaches are directed to reducing the search time required for searching over a large database using methods such as binary searches or b-trees both of which require that the data in the database can be read randomly. In order to support random reading from a compressed database, the entire database must be decompressed.

There is a need in the art for a database having a compressed data structure enabling manipulation and/or query of the data without requiring decompression of the entire database prior to use. That is, the database remains compressed and occupies a smaller storage space thereby requiring less memory and less transmission time to transfer the database contents.

For example, handheld or embedded devices are constrained by limited processing power and limited storage or memory in order to increase the device's battery life. A compressed database would enable a larger amount of data to be stored on the device. However, prior approaches have always decompressed the entirety of the data prior to use on the device thereby eliminating any advantage gained from database compression.

### SUMMARY

It is therefore an object of the present invention to provide a compressed data structure for a database.

Another object of the present invention is to provide a mechanism for manipulating data in the database without requiring decompression of the entire database.

The present invention provides a method and computer-readable medium containing instructions for storing data in a compressed data structure. Access and update of the data is primarily in compressed form yielding a reduced storage requirement for storing the data. The data structure is structured to enable a reduced data search and access time for finding and accessing data in the compressed data structure.

A method aspect of storing data in a compressed data structure includes receiving data for storage. The data is stored in compressed form in one or more uniquely identified data pages along with configuration information stored in at least one configuration file. Index information is stored in one or more uniquely identified index pages. The index information includes pointers to data in the uniquely identified data pages and data from one or more fields of data from the uniquely identified data pages. The index information in the index pages is ordered based on the stored index information data from one or more fields of data from the data pages and the ordering basis is stored in configuration information in the one or more configuration files.

A computer-readable medium aspect includes instructions for execution by a processor to cause the processor to store, access, and modify data in a compressed data structure. The computer-readable medium includes a data structure for a compressed database and at least one sequence of machine executable instructions in machine form. The compressed database includes one or more uniquely identified data pages for storing data, one or more configuration files, and one or more uniquely identified index pages. The index pages include a pointer field for storing a pointer to data in the data pages and a data field for storing data from a field of the data pages. The sequence of instructions includes instructions which, when executed by a processor, cause the processor to store data in the data pages.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level block diagram of a logical architecture with which an embodiment of the present invention may be used;

FIG. 2 is a high level block diagram of an exemplary computer upon which an embodiment of the present invention may be used;

FIG. 3 is a high level block diagram of a portable software architecture usable with an embodiment of the present invention; and

FIG. 4 is a high level block diagram of a compressed data structure for a database as used in an embodiment of the present invention.

### DETAILED DESCRIPTION

In coordination with the above-referenced related applications, an embodiment of the present invention provides the file structures and functionality to deliver a compressed database for use with a unified service to manage multi-platform data retrieval such as the unified service described above.

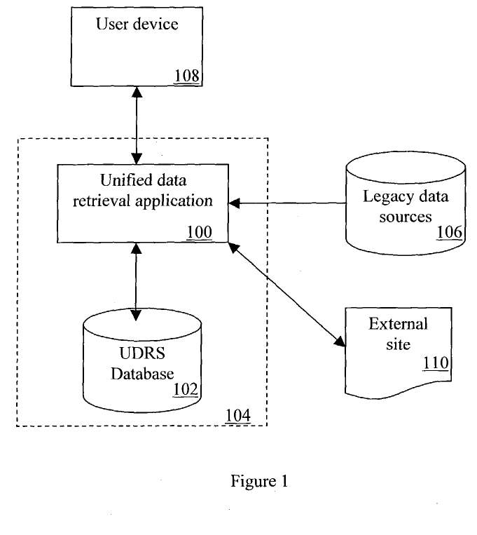

FIG. 1 is a high level diagram of the unified service logical architecture in conjunction with which an embodiment of the present invention may be used. As described in detail in “Unified Service to Manage Multi-Platform Data Retrieval,” assigned to the present assignee and hereby incorporated by reference in its entirety, a unified data retrieval application 100 and a unified data retrieval service (UDRS) database 102 in combination make up a unified data retrieval service 104. The UDRS 104 accesses legacy data sources 106, e.g. lightweight directory authentication protocol (LDAP) directory servers, human resources databases, and other databases, to obtain additional information. The additional information may be obtained on a scheduled basis or responsive to a user query received from a user manipulating a user device 108, e.g. a web browser executing on a handheld device, connected to UDRS 104. Additionally, requests may be received and responded to by accessing information stored at external site 110, for example, www.e-cardfile.com. In this manner, the UDRS 104 obtains information from multiple data sources and provides information in response to user requests.

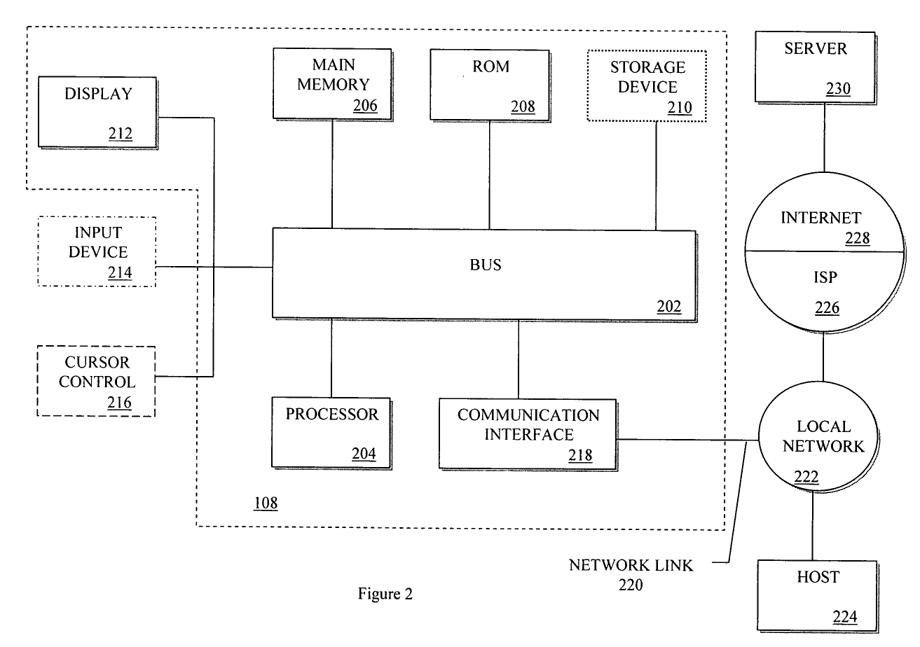

FIG. 2 is a block diagram illustrating an exemplary computer or user device 108, e.g. a handheld device, upon which an embodiment of the invention may be implemented. The present invention is usable with currently available handheld and embedded devices, and is also applicable to personal computers, mini-mainframes, servers and the like.

Computer 108 includes a bus 202 or other communication mechanism for communicating information, and a processor 204 coupled with the bus 202 for processing information. Computer 108 also includes a main memory 206, such as a random access memory (RAM) or other dynamic storage device, coupled to the bus 202 for storing a data structure for a compressed database according to an embodiment of the present invention and instructions to be executed by processor 204. Main memory 206 also may be used for storing temporary variables or other intermediate information during execution of instructions to be executed by processor 204. Computer 108 further includes a read only memory (ROM) 208 or other static storage device coupled to the bus 202 for storing static information and instructions for the processor 204. A storage device 210 (dotted line), such as a compact flash, smart media, or other storage device, is optionally provided and coupled to the bus 202 for storing instructions.

Computer 108 may be coupled via the bus 202 to a display 212, such as a flat panel touch-sensitive display, for displaying an interface to a user. In order to reduce space requirements for handheld devices, the display 212 typically includes the ability to receive input from an input device, such as a stylus, in the form of user manipulation of the input device on a sensing surface of the display 212. An optional input device 214 (dash dot line), such as a keyboard including alphanumeric and function keys, is optionally coupled to the bus 202 for communicating information and command selections to the processor 204. Another type of optional user input device is cursor control 216 (long dash line), such as a stylus, pen, mouse, a trackball, or cursor direction keys for communicating direction information and command selections to processor 204 and for controlling cursor movement on the display 212. This input device typically has two degrees of freedom in two axes, a first axis (e.g., x) and a second axis (e.g., y) allowing the device to specify positions in a plane.

The invention is related to the use of computer 108, such as the depicted computer of FIG. 2, to store and access data in a compressed data structure for a database. According to one embodiment of the invention, data is stored and accessed from a database by computer 108 in response to processor 204 executing sequences of instructions contained in main memory 206 in response to input received via input device 214, cursor control 216, or communication interface 218. Such instructions may be read into main memory 206 from another computer-readable medium, such as storage device 210. A user interacts with the database via an application providing a user interface displayed (as described below) on display 212.

However, the computer-readable medium is not limited to devices such as storage device 210. For example, the computer-readable medium may include a floppy disk, a flexible disk, hard disk, magnetic tape, or any other magnetic medium, a compact disc-read only memory (CD-ROM), any other optical medium, punch cards, paper tape, any other physical medium with patterns of holes, a random access memory (RAM), a programmable read only memory (PROM), an erasable PROM (EPROM), a Flash-EPROM, any other memory chip or cartridge, a carrier wave embodied in an electrical, electromagnetic, infrared, or optical signal, or any other medium from which a computer can read. Execution of the sequences of instructions contained in the main memory 206 causes the processor 204 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer 108 also includes a communication interface 218 coupled to the bus 202 and providing two-way data communication as is known in the art. For example, communication interface 218 may be an integrated services digital network (ISDN) card, a digital subscriber line (DSL) card, or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals which carry digital data streams representing various types of information. Of particular note, the communications through interface 218 may permit transmission or receipt of instructions and data to be stored and accessed from the database. For example, two or more computers 108 may be networked together in a conventional manner with each using the communication interface 218.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals which carry digital data streams. The signals through the various networks and the signals on network link 220 and through communication interface 218, which carry the digital data to and from computer 108, are exemplary forms of carrier waves transporting the information.

Computer 108 can send messages and receive data, including program code, through the network(s), network link 220 and communication interface 218. In the Internet example, a server 230 might transmit a requested code for an application program through Internet 228, ISP 226, local network 222 and communication interface 218. In accordance with an embodiment of the present invention, computer 108 interacts with the UDRS 104, e.g. on a server 230, to retrieve and update information stored on the UDRS 104 via Internet 228, ISP 226, local network 222, and communication interface 218.

The received code may be executed by processor 204 as it is received, and/or stored in storage device 210, or other non-volatile storage for later execution. In this manner, computer 108 may obtain application code in the form of a carrier wave.

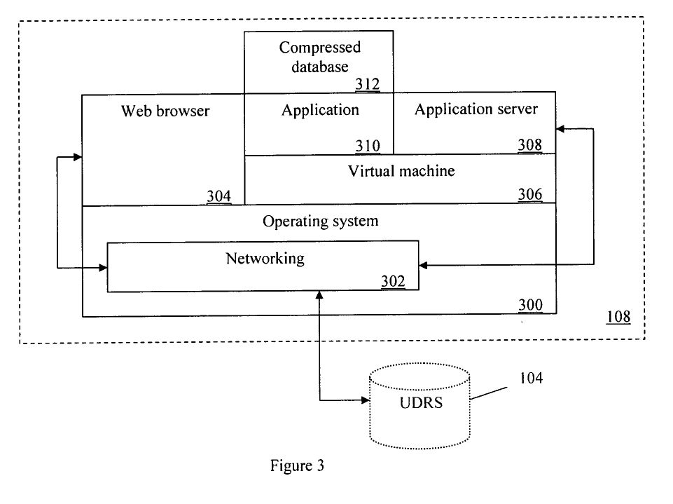

Referring now to FIG. 3, a high level block diagram depicts a portable software architecture as described in detail in co-pending application titled, “Portable Software Architecture,” assigned to the present assignee, and hereby incorporated by reference in its entirety. A computer 108 includes an operating system 300, stored in ROM 208 and main memory 206, having a networking component 302. The processor 204 executes operating system 300 instructions from memory 206 and/or ROM 208. Instructions for a web browser 304, as is known in the art, are executed by the processor 204 and access functionality provided by the operating system 300 including functionality of networking component 302. Although web browser 304 is shown and described as a native software application, it is to be understood that in alternate embodiments web browser 304 can be a virtual machine-based web browser, e.g., a JAVA-based web browser executing on a JAVA virtual machine (JVM). JAVA is available from Sun Microsystems, Inc. Web browser 304 is a display and input interface for the user, i.e. the browser window is used to present information to the user and the same window is used to receive input from the user in the form of buttons, checkboxes, input fields, forms, etc.

Virtual machine 306 instructions are executed by processor 204 and cause the processor to access functionality provided by the operating system 300, e.g. function calls or method invocations. Virtual machine 306 executes a web application server 308 instructions to provide application serving functionality. In particular, web application server 308 executes an application 310 instructions in response to HTTP requests received by the web application server 308 from networking component 302. The application 310, interacting with the user provides the functionality requested by the user. For example, the application 310 may be a personal information management (PIM) software application managing contacts and related information for a user. The application 310 may be any software application desired by the user subject to memory and processing functionality.

The user interface displayed to the user for interacting with the application 310 is displayed by the web browser 304. The user interface, i.e. web browser 304, and the application 310 communicate using standard networking protocols, such as HTTP. HTTP requests and responses communicated between the web browser 304 and the application 310, are sent via the built-in networking component 302 of the operating system 300, using the same networking protocols that web browser 304 and application 310 would use if they were communicating over a network between different computing devices. Typically, the network protocol used is TCP/IP, but those skilled in the art will appreciate that other networking protocols could be substituted.

The application 310 does not send or receive networking messages directly, but rather the web application server 308 acts as a proxy and manages all network communication between the application 310 and the web browser 304. The web application server 310 and application 308 communicate via standard methods known to those skilled in the art.

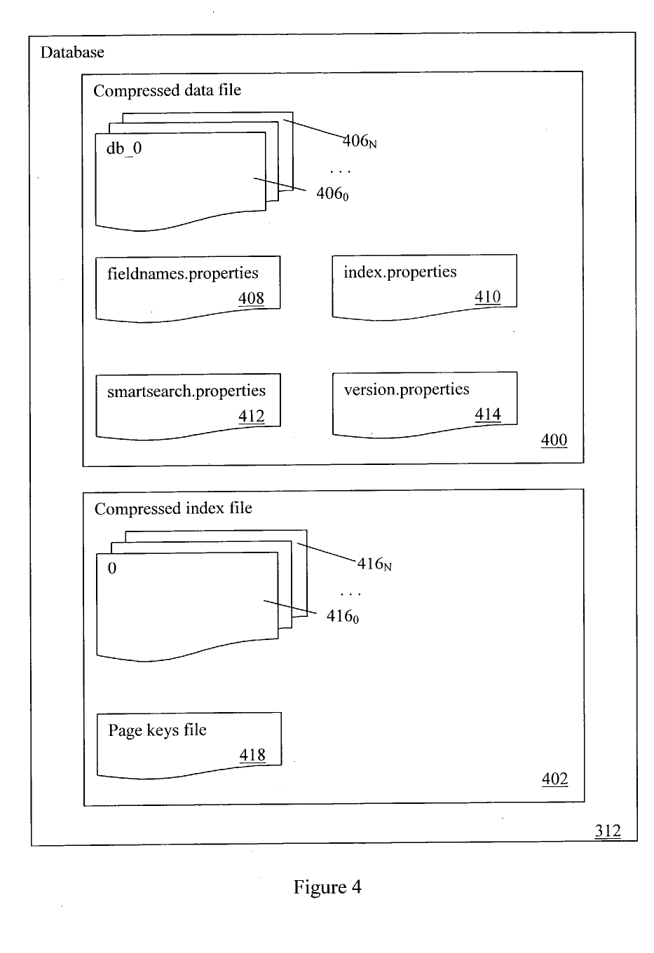

Of note, FIG. 3 further includes a compressed database 312 according to an embodiment of the present invention for storing data accessed by the application 310. The compressed database 312 is utilized by the example software application of FIG. 3 and stored either in main memory 206 or storage device 210 of computer 108. As depicted in FIG. 4, database 312 includes a compressed group of files collectively forming the database. These files include a compressed data file 400 and a compressed index file 402.

A particular embodiment of the present invention employs the commonly used “zip”-type compression for compressing the files. The zip compression algorithms and file formats are known to persons of skill in the art. Zip compression software and libraries are available from multiple sources including PKWARE of Brown Deer, Wis. and Sun Microsystems, Inc. of Santa Clara, Calif. The type of compression used is not important as long as the needed functionality described below is supported, that is to say, it will be understood by persons of skill in the art that other compression formats are usable in conjunction with the present invention.

There may be more than one database 312 on each user device 108; however for clarity, only a single database will be described herein with reference to an embodiment of the present invention. Each database 312 contains the data file 400 and the index file 402 each in compressed form for a given database. Data file 400 is stored together with the corresponding index file 402 of the database 312 and in a particular embodiment data file 400 has a filename extension of “.ddb.” Index file 402 is stored with data file 400 and includes the index name in the filename and in a particular embodiment index file 402 has a filename extension of “.idx.”

Data File

The database data is in the compressed data file 400 and is a compressed file with the extension changed to .ddb, e.g. database.ddb. Compressed data file 400, in turn, is made up of a collection of files 406₀-406_{N}, also referred to as pages, and a plurality of configuration files, specifically a fieldnames properties file 408, an index properties file 410, a smartsearch properties file 412, and a version properties file 414. In one particular embodiment, the pages 406₀-406_{N} are named db_[seq] where [seq] is a sequence number beginning with zero (0) and incrementing sequentially.

Pages 406₀-406_{N} are ordered by the sequence number. Each page 406₀-406_{N} stores a portion of the database data and in a particular embodiment carriage returns delimit individual records and tabs delimit individual fields. Using the key pages file 418 (described in detail below), a particular index page 416₀-416_{N} (also described in detail below) containing pointers to the compressed data pages 406₀-406_{N} is identified and decompressed. The decompressed index page 416₀-416_{N} is searched to identify the appropriate data page 406₀-406_{N} containing the searched for data. In this manner, only a portion of the entire database is decompressed for a given search.

Database Configuration Files

The compressed database.ddb file includes both pages 406₀-406_{N} and a set of configuration files. The configuration files include:

fieldnames.properties;

index.properties;

smartsearch.properties; and

version.properties.

Fieldnames properties file 406 is a tab delimited file aligned with the pages 406₀-406_{N} such that each entry in fieldnames file 408 corresponds to a field in pages 406₀-406_{N}. The number of entries in fieldnames properties file 408 equals the number of fields or entries for each record in pages 406₀-406_{N}.

Index properties file 410 identifies the available indices for searching database 312. The entries in index properties file 410 is also used for building the indices with the update process described in detail in co-pending application titled, “Method of Updating a Compressed Data Structure,” assigned to the instant assignee, and hereby incorporated by reference in its entirety. The index properties file 410 can list any of the fields named in fieldnames properties file 408.

Index properties file 410 is structured as a series of two field records and tabs delimit the fields and carriage returns delimit the records. The first field is the index name and the second is a filter applied to index values prior to indexing for creating a compressed index file 402. The filter changes the index value so that transformations on the data, i.e. the index value stored in memory prior to indexing, can be performed. In this manner, transformation of the index value is performed in memory prior to indexing and the transformed value is written to the index file 402. The original data page 406₀-406_{N} data is not modified in the data file 400 Examples of filters include soundex, or removing non-alphabetic characters.

Smart search is a method for searching database 312 based on a single string entry. Smart search analyzes the string and determines which set of indices and fields are appropriate for the search.

In one particular embodiment, smartsearch properties file 412 is formatted and read as a standard java language-based properties file. The smart searches displayed by the system for automatic index selection are based on the smartsearch properties file 412.

Each smartsearch properties file 412 entry includes the name of the search and the name of the property being searched, e.g. in one particular embodiment, the name of the search preceds the name of the property as in searchname.property. Each of the properties are as follows:

match—a regular expression that is true if the string matches this search;

value—a regular expression that returns the search results as the parameters of the expression;

index—comma delimited index files that match the results returned by the value regular expression;

label—a label that can be used to identify the search on a graphical user interface (GUI);

filter—a class that can be used to filter the result value;

order—the evaluation order; and

listOrder—label order that can be used to display in a GUI.

Version properties file 414 is used by an updater or any other process to determine the version of the current database and in a particular embodiment, contains a single numeric entry in the format YYYYMMDD indicating the date of the database 312.

Index File

Index file 402 is stored with data file 400 and uses a filenaming convention such that the filename is of the format name-filter.idx, where name is the field name that is indexed and filter is the name of the filter that is applied.

In a manner similar to data file 400, the index file 402 is a compressed file including a set of index data files, referred to as index pages 416₀-416_{N}, and a page keys file 418. In a particular embodiment, the index pages 416₀-416_{N} have a sequentially incrementing integer as a file name, starting with zero (0) and incrementing until all of the data is contained in the index pages 416₀-416_{N}.

Within each index page 416₀-416_{N}, the index data is stored as a repeating series of compressed pointer and index data and, in one embodiment, tabs are used to delimit each record. The index data of the index record is a copy of the indexed field in data file 400. Advantageously, because the index file 402 is compressed it is not necessary to attempt to minimize duplication as the compression of the index file handles the duplication elegantly. That is, processing time and capability and storage space need not be used to remove duplicate records from the compressed index file 402 because the compression of the index file 402 is used for this purpose without requiring additional functionality of the accessing or updating software application, e.g. application 310. For example, simply repeating the field value from the data page field in conjunction with a pointer is not an efficient storage structure; however, when used in conjunction with compression of the index file 402 much of the redundancy of the storage structure is removed.

Data within the index pages 416₀-416_{N} is ordered from first to last and each individual index page 416₀-416_{N} is identified by a zero based sequentially incrementing integer filename. Each record within an index page 416₀-416_{N} includes a pointer identifying the location of the corresponding record in the data file 400. In a particular embodiment, the pointer is an eight digit pointer value. The first three digits of the pointer value identify the data file page 406₀-406_{N} in which the corresponding record is located. The second five digits of the pointer value identify the offset from the start of the page 406₀-406_{N} in which the corresponding record is located.

In the embodiment described above, the eight digit pointer value is compressed into 4 bytes by taking the first 4 bits and last 4 bits of each byte to represent two digits in the pointer as shown in Table 1 below.

TABLE 1

| Data file page | | | Page offset | | | | |
|---|---|---|---|---|---|---|---|
| 0101 | 0111 | 0010 | 1000 | 0110 | 0100 | 0011 | 0001 |
| 5 | 7 | 2 | 8 | 6 | 4 | 3 | 1 |

Based on the example data of Table 1, the pointer value identifies a record in data file 406₀-406_{N} having a filename of “db_{—}572” as corresponding to the indexed record. Further, the Table 1 pointer value identifies the record as being at an offset of “86431” in the identified data file 406₀-406_{N}. Using this information, application 310 is able to quickly locate and extract data from compressed data file 400.

Page keys file 418 is included in the compressed index file 402 in order to increase the speed of locating and loading a particular index into memory 206. Page keys file 418 specifies the number of keys (index results), the key name, the number of pages in the index file 402, and a list of the index value of the last entry on each index page. A particular embodiment of page keys file 418 has the following tab-delimited format:

number of keys;

key name;

number of pages; and

the index value of the last entry on each index page with each value separated by a tab.

Processor 204 (FIG. 2) reads page keys file 418 prior to creating the index and storing the index in memory 206. Using the page keys file 418, the processor is able to allocate the required memory without having to determine the index size by traversing the index. The created index data structure is then read by the processor 204 executing instructions of an index search routine to establish in which index page the candidate key is stored.

The first three entries, i.e. number of keys, key name, and number of pages, are used by an index search algorithm to allocate memory for an index data structure. The repeating index value of the last entry are used by the index search algorithm to establish on which index page 416₀-416_{N} a particular key is stored. The index search algorithm scans down the array of last entry index values and compares each entry index value to the searched for key. If the search key is less than or equal to the last entry index value being inspected, then the key is stored in the index page 416₀-416_{N} associated with the last entry. If the search key is greater than the last entry index value being inspected, then the algorithm specifies a comparison be performed with the next index value entry.

Use of the page keys file 418, enables direct access to the required index page 416₀-416_{N} containing the searched for key value. Once the appropriate index page 416₀-416_{N} is identified, the identified index page is decompressed, loaded into memory 206, and is searchable using standard search algorithms. Only a single page of the index pages 416₀-416_{N} needs to be decompressed thereby saving time and storage space.

Seek

When a seek is performed against the database 312, the key, or searched for value, and index file 402 are provided to the search algorithm. The index file 402 is accessed and previously cached keys are compared to the current key to identify the index page 416₀-416_{N} on which the key is stored.

The identified index page 416₀-416_{N} is then accessed from the index file 402. The identified index page 416₀-416_{N} is scanned sequentially until the key being examined is greater than or equal to the searched for key.

If the examined key is greater, then the searched for key is not held in the index file 402.

If a key match is identified, the pointer value for matching keys is retrieved from the identified index page 416₀-416_{N}. The pointer value is used to identify the data page 406₀-406_{N} and page offset from which the data is retrieved.

Smart Search

Smart Search is an algorithm for identifying which indices and keys to use to perform a search given a single string of data.

An ordered list of regular expressions is compared to the string and the first matching regular expression identifies the search or filter to be applied. Regular expressions are known to persons of skill in this art.

Once the search has been identified, a second regular expression is applied against the string to extract the keys. The second regular expression may be the match or value regular expressions described above with respect to the smartsearch properties file 412.

The identified search then applies the search keys against the indices held in the smartsearch properties file 412 data structure and performs the search.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of storing data in a compressed data structure comprising:
storing data in compressed form in one or more uniquely identified data pages;
storing configuration information in compressed form in one or more configuration files;
storing index information in compressed form in one or more uniquely identified index pages, wherein the index information includes (1) pointers to data in the uniquely identified data pages and (2) data from one or more fields of data from the uniquely identified data pages;
ordering the index information in the one or more uniquely identified index pages based on (2) and storing the ordering basis in configuration information in the one or more configuration files.

2. The method of claim 1, wherein the configuration information comprises fieldname information, index information, smartsearch information, and version information.

3. The method of claim 1, further comprising the step of:
performing a seek using a searched for value and the index.

4. The method of claim 1, further comprising the step of:
storing index page information in compressed form in a page keys file.

5. The method of claim 4, wherein the index page information includes a number of keys, key name, number of index pages, and an index value of a last entry on each index page.

6. The method of claim 1, wherein the index information pointer is a compressed pointer.

7. The method of claim 6, wherein the compressed pointer identifies the data page and page offset of the referred to data.

8. The method of claim 2, wherein the smartsearch information includes at least one of a match property, a value property, an index property, a label property, a filter property, an order property, and a listOrder property.

9. A computer-readable medium comprising:
a data structure for a compressed database comprising:
one or more uniquely identified data pages;
one or more configuration files; and
one or more uniquely identified index pages, wherein the index pages includes (1) a pointer field for pointers to data in the one or more uniquely identified data pages and (2) a data field for data from one or more fields of data from the uniquely identified data pages;
at least one sequence of machine executable instructions in machine form, wherein execution of the instructions by a processor cause the processor to:
store data in the one or more uniquely identified data pages.

10. The medium of claim 9, further comprising instructions which, when executed by the processor, cause the processor to:
store index information in compressed form in the one or more uniquely identified index pages.

11. The medium of claim 10, wherein the instructions to store index information further comprise instructions which, when executed by the processor, cause the processor to:
order the index information in the one or more uniquely identified index pages based on the data field value.

12. The medium of claim 11, wherein the instructions to store index information further comprise instructions which, when executed by the processor, cause the processor to:
store the ordering basis in the one or more configuration files.

13. The medium of claim 9, wherein the one or more configuration files is structured to store fieldname information, index information, smartsearch information, and version information.

14. The medium of claim 9, further comprising instructions which, when executed by the processor, cause the processor to:
store index page information in compressed form in a page keys file.

15. The medium of claim 14, wherein the index page information includes a number of keys, key name, number of index pages, and an index value of a last entry on each index page.

16. The medium of claim 9, wherein the index information pointer is a compressed pointer.

17. The medium of claim 16, wherein the compressed pointer identifies the data page and page offset of the referred to data.

18. A method of searching for data in a compressed data structure, wherein the compressed data structure includes (1) data stored in compressed form in one or more uniquely identified data pages, (2) configuration information stored in compressed form in one or more configuration files, (3) index information stored in compressed form in one or more uniquely identified index pages, and (4) index page information stored in compressed form in a page keys file, wherein the index information includes pointers to data in the uniquely identified data pages and data from one or more fields of data from the uniquely identified data pages, and wherein the index page information include an index value of a last entry on each index page, the method comprising the following steps:
decompressing the index page information from the page keys file;
searching for a searched for key in the decompressed index page information;
if the searched for key is found, determining the index page having the searched for key and decompressing the determined index page;
searching for a searched for value in the decompressed index page;
if the searched for value is found, determining the data page having the searched for value and decompressing the determined data page; and
locating the data in the determined data page.

19. The method of claim 18, wherein the determined data page is determined using the index information from the value found in the determined index page.

20. The method of claim 19, wherein the determined data page is determined using the pointer to the data in the data pages corresponding to the value found in the determined index page.
